(19) United States
(12) Patent Application Publication
(10) Pub. No.: US 2009/0146025 A1
(43) Pub. Date: Jun. 11, 2009

(54) Trophy Assembly With Twist Connector

(75) Inventor: William Schwartz, Land O'Lakes, FL (US)

Correspondence Address: CARLTON FIELDS, P.A.;Attn: IP Dept., P.O. BOX 3239, TAMPA, FL, 33601-3239, US

(73) Assignee: WILLIAM STEVEN SCHWARTZ REVOCABLE TRUST, Land O'Lakes, FL (US)

(21) Appl. No.: 11/952,630

(22) Filed: Dec. 7, 2007

(51) Int. Cl. F16M 13/00

(52) U.S. Cl. 248/159

(57) ABSTRACT

A trophy assembly including a base, lower clip, and column having inwardly extending ribs adapted to engage the lower clip, wherein the base and column are joined when the column is placed over the lower clip and rotated. A method for assembling trophies including selecting a base, column with internal ribs, and a clip, attaching the clip to the base, forming slots in interior ribs of the column, placing the column over the clip and rotating it, whereby the base and column are joined. A trophy assembly further including upper clips adapted to engage inwardly extending column ribs and attached to upper members, wherein the base, column, and upper member are joined when the column is rotated.

### BACKGROUND OF THE INVENTION

This invention relates to trophy assemblies utilizing plastic columns sold by awards dealers and typically used to commemorate sports victories and other achievements.

Typical conventional trophy assemblies comprise a base, a lower lid, a column, an upper lid and a figure symbolic of the achievement. Larger trophy assemblies may comprise additional columns mounted to create multi-level trophies with the figure on the top. Historically, trophies utilizing columns have been assembled using threaded rods that run through the base, the lower lid, the column, the upper lid and then attach to the figure using a coupler. A nut is then used to secure the base to the rod and compress the base, lower lid, column, upper lid, and figure together, thereby creating a rigid assembly.

The conventional threaded rod design has several disadvantages. One disadvantage is that the nut, threaded rod, and coupler (the “hardware”) contribute more than 30% of the number of components of a typical small trophy. This impacts the cost and weight of the final assembly, increases inventory and freight expenses, and requires substantial space for inventory. More importantly, assembling even the smallest of such trophies is a labor intensive process, typically requiring between 36 and 52 discrete steps, counting rotations and alignment of components. Accordingly, the average awards dealer must incur high labor costs, often necessitating the hiring of part time employees and payment for numerous overtime hours, to repeatedly complete this laborious process in order to have a sufficient number of awards ready in time for ceremonies during peak season. These disadvantages arise primarily from the structural design being based on threaded rods and compression for structural rigidity.

It is an object of the present invention to provide a trophy assembly that can be assembled quickly and easily by using a column design that enables the column itself to become a structural element that holds the assembly together, thereby eliminating the need for the threaded rods and associated hardware. It is a further object of this invention to provide a method of assembling trophies that eliminates the need for steps involving the use of a threaded rod, such method comprising selecting bases, columns, and upper members or figures, forming slots in the column ribs, and joining the base, column and upper members together by twisting the column member onto molded-in or pre-attached upper and lower clips so that the clips engage the ribs. Other objects and advantages of the present invention are made clear to those skilled in the art by the following description of the presently preferred embodiments thereof.

### SUMMARY OF THE INVENTION

In accordance with the present invention there is provided a trophy assembly having a base, a column, and a lower clip attached to the base. The column has a first end and a second end. The first end has an interior surface with at least one inwardly extending lower rib and is dimensioned and configured to fit over the lower clip. Upon rotating the column, the lower clip engages the lower rib, whereby the base and column are joined together. Also in accordance with the present invention there is provided a method of assembling trophies comprising the steps of selecting a base and a column having an interior surface at one end with at least one inwardly and longitudinally extending lower rib, forming a slot in the rib proximate to the end, and joining the base to the column by placing the column over the clip and rotating the column so that the clip enters the slot and engages the rib.

In preferred embodiments of the present invention, the column design utilizes internal ribs that engage locking clips when the column is placed over the clip and rotated. In such embodiments, the locking clips can be attached to bases using traditional coupling means, such as a nut and bolt or ferrule, by molding the clip into a recessed area on the top of the base, or by adhesive or other similar means well known in the art. If traditional coupling means are utilized, the clips may be pre-attached to the bases, either by the manufacturer or the dealer, to reduce the time and effort required for final assembly. Similarly, locking clips can be attached to upper elements or figures using the same means. In the case of embodiments with figures, the figure may comprise a locking clip molded into a recessed area on the bottom of the figure, adapted such that the figure can be placed on the top of the column and rotated to lock the figure to the column, thereby completing the assembly. As with bases, if traditional coupling means are used to secure the clip to the upper elements or figures, the clips can be pre-attached, either by the manufacturer or the dealer, so that final assembly time is reduced. As a result, with preferred embodiments of the present invention, a small trophy may be assembled from only three components, a figure with a molded-in or pre-attached locking clip, a column with internal ribs, and a base with a molded-in or pre-attached locking clip and would take only 15 steps. In contrast, a similar trophy assembly utilizing a traditional threaded rod construction would require the assembly of eight components utilizing between 36 and 52 steps.

Certain preferred embodiments also provide design flexibility to dealers. In such embodiments, the quick-connect feature of allows dealers to quickly and easily create a myriad of new and distinctive designs by mixing and matching different bases, columns, and figures. While bases and figures with pre-attached clips minimize assembly time and effort, still further flexibility is achieved with alternative embodiments utilizing lids, with pre-attached clips and separate clips, which may be used in connection with an even wider variety of bases and figures. For example only and without limitation, a column lid with a pre-mounted locking clip enables dealers to attach traditional figures to an internally ribbed column in the same way that they would attach a figure with a molded-in clip. With such a column lid, a dealer can insert the threaded stud of any figure through the center hole of the lid and attach it with a nut or similar means. Then the dealer can place the lid with the attached figure on the top of the column and rotate it so that it is attached to the column in the same way as a figure with a molded-in clip. Similarly, such column lid can be mounted on the top of trophy bases using similar means. A column can then be inserted into the lid and rotated, whereby the column is attached to the lid and base. As a result, preferred embodiments of the present invention provide dealers with a great degree of flexibility and choice while simultaneously reducing time, effort and cost of assembly.

Additional embodiments of the present invention extend to trophy assemblies with multiple columns, with correspondingly greater labor savings. Traditionally, multi-column trophies have separate threaded rods and hardware within each column, each of which requiring multiple labor steps to assemble. Utilizing multi-column embodiments of the present invention, a dealer may insert all of the columns into bases with molded-in or pre-attached clips, place an upper member also having molded-in or pre-attached clips over the tops of the columns and then rotate each column to lock the entire trophy together. Lids may also be used in such embodiments and in conjunction with a variety of bases and upper members to create trophies of varying appearance.

### BRIEF DESCRIPTION OF THE DRAWINGS

Other features in the invention will become apparent from the attached drawings, which illustrate certain preferred embodiments of the trophy assembly and method of this invention, wherein

FIG. 1 is an exploded view of one preferred embodiment of the trophy assembly of this invention with a base, two lids, a single column, and a figure;

FIG. 2 is an exploded view of one preferred embodiment of the trophy assembly of this invention with a base with integrated clip, a column, and a figure with an integrated clip;

FIG. 3 is an exploded view of one preferred embodiment of the trophy assembly of this invention with a base and single column, but without a lid element;

FIG. 4 is a cut-away view of a column member utilized in a preferred embodiment of the present invention;

FIG. 5 is a cut-away view of an alternate configuration of a column member used in a preferred embodiment of the present invention and having discontinuous internal ribs proximate to the column ends;

FIG. 6 is an exploded view of a second alternate configuration of a column member comprising a central column body and two inserts;

FIG. 7 is a plan view of one configuration of a clip member used in a preferred embodiment of the trophy assembly of this invention;

FIGS. 8-10 are perspective views of alternate configurations of clip members used in embodiments of the present invention;

FIG. 11 is a perspective view of a tab element of a further configuration of a clip member used in an embodiment of the present invention;

FIGS. 12-16 are inverted plan views illustrating configurations of clip members engaging column elements as used in embodiments of the present invention;

FIG. 17 is an exploded, perspective view, illustrating a preferred embodiment of the present invention utilizing an alternate configuration of a base member;

FIG. 18 is a phantom, perspective view, illustrating an alternate configuration of a base member assembled with a column member, as utilized in a preferred embodiment of the present invention;

FIG. 19 is a phantom, perspective view, illustrating an alternate configuration of an assembled base member, lid member, and column member, as utilized in a preferred embodiment of the present invention;

FIG. 20 is a plan view, partially shown in phantom, illustrating a lid member with integrated clip and stop as used in a preferred embodiment of the present invention;

FIG. 21 illustrates a base with an alignment hole and a lid with alignment protrusion, as used in a preferred embodiment of the present invention;

FIG. 22 illustrates an exploded, perspective view of a multi-column embodiment of the present invention;

FIG. 23 is an exploded, perspective view of a single-column embodiment of the present invention; and

FIGS. 24 and 25 are flowchart representations of the methods of preferred embodiments of the present invention.

### DESCRIPTION OF PREFERRED EMBODIMENTS

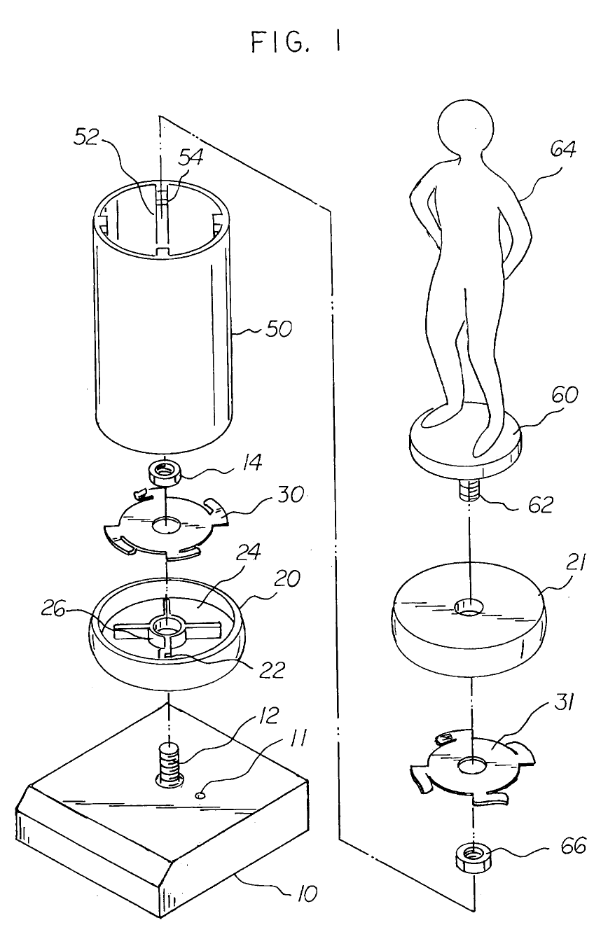

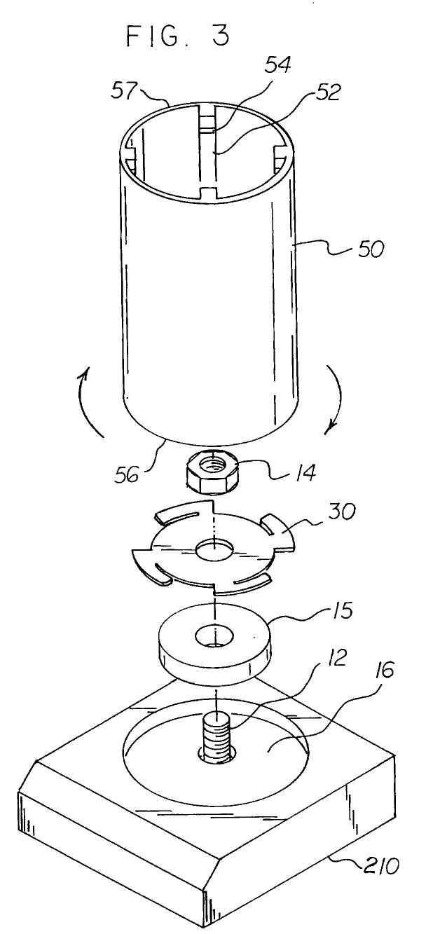

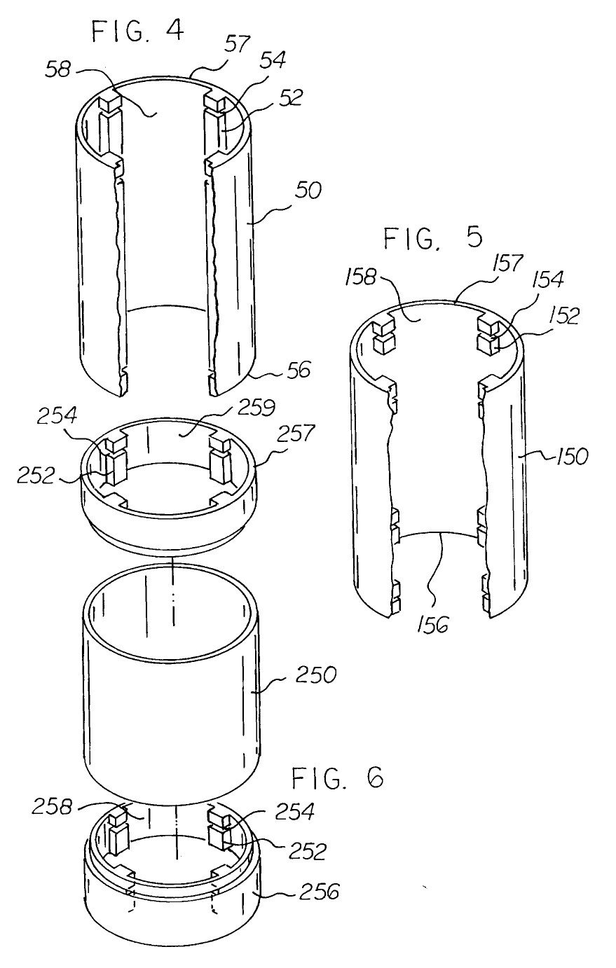

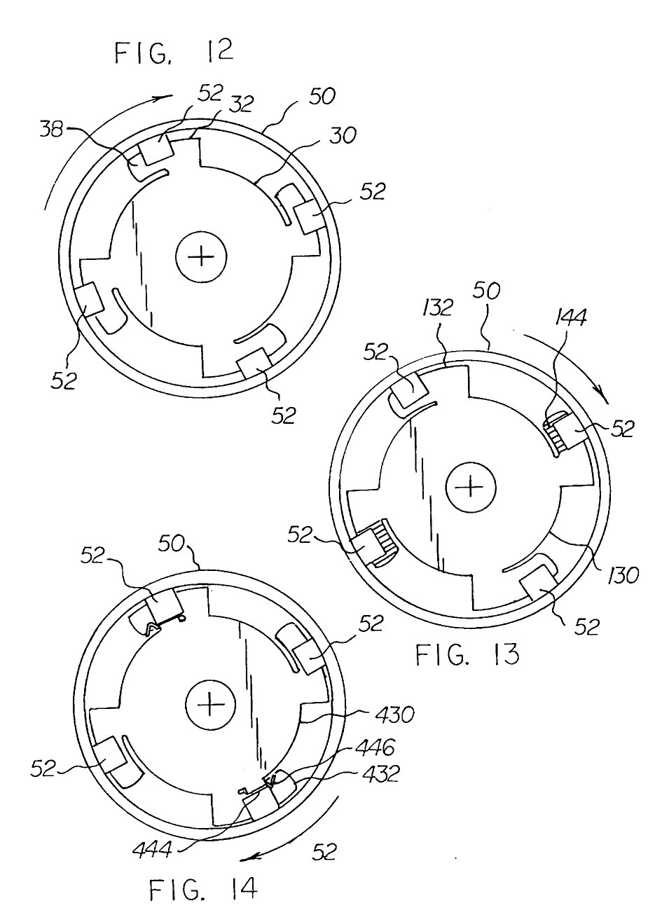

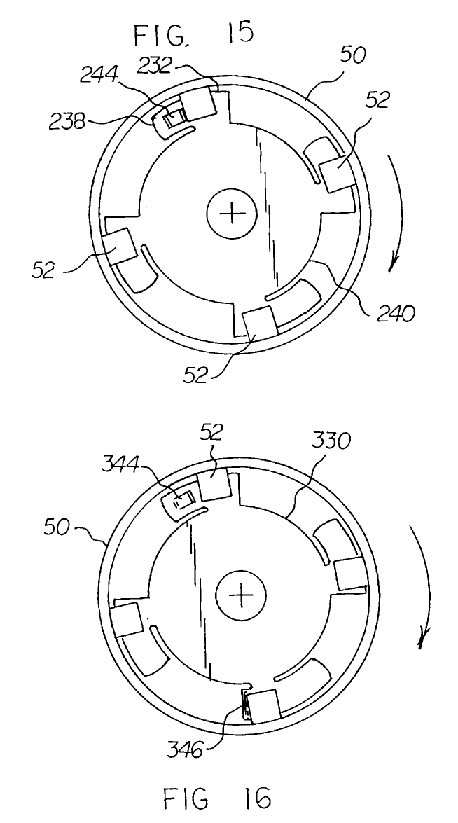

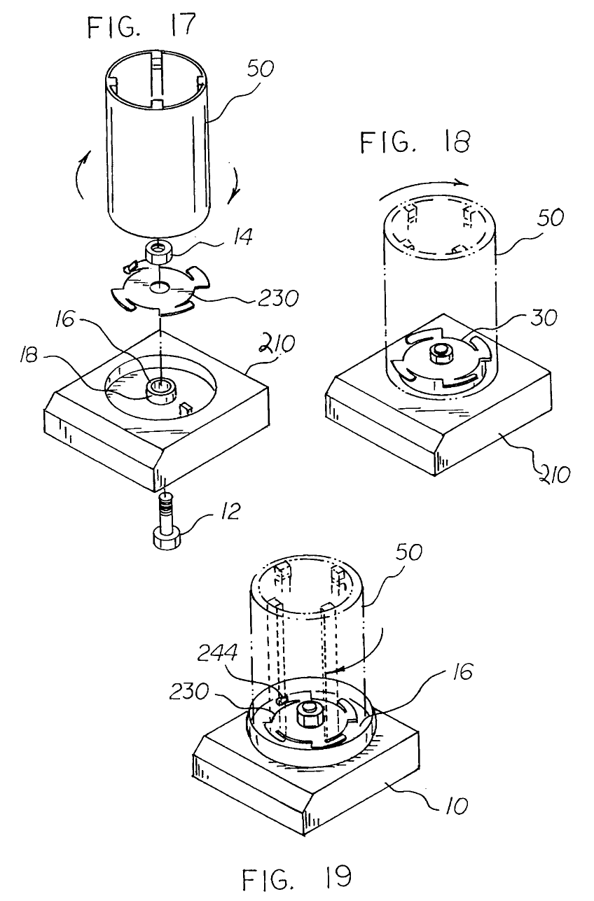

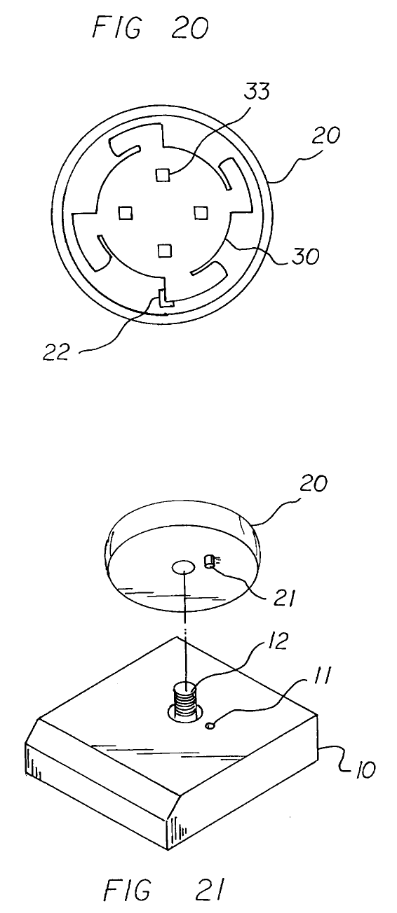

FIGS. 1-25 illustrate preferred embodiments of the trophy assembly and methods of this invention. This trophy assembly generally comprises a base member 10, 110, 210 a column member 50, and a lower clip member 30 attached to said base member. Each column member 50 is generally hollow and has two ends 56, 57 and an inside surface 58. In this specification, “adapted” shall mean configured, dimensioned, arranged, and oriented as appropriate and, accordingly, column member 50 is preferably in the form of a generally cylindrical, hollow tube, adapted to fit over lower clip member 30 such that column member 50 can be rotated about lower clip member 30. Column member 50 may also conveniently be ellipsoidal, triangular, octagonal, or in many other configurations known in the art, including riser configurations comprising one or two generally cylindrical ends and middle portions of arbitrary shape or design. Column member 50 may conveniently be formed of extruded plastic with at least two, and preferably four, continuous, inwardly and longitudinally extending interior rib elements 52 running the length of interior surface 58. Alternatively, column member 150 may be formed from extruded or molded plastic having lower rib elements 152 attached or formed on interior surface 158, but only proximate to column ends 156 or 157. In another alternate configuration, column member 250 may be formed from a central member and inserts 256 and 257 adapted to fit either partially or entirely within column member 250, thereby allowing for creation of column members of any convenient length, without requiring rib elements 52 running the entire length of the column. In such a configuration, inserts 256 and 257 may conveniently have rib elements 252 formed on, or attached to, inside surface 258, 259 of inserts 256, 257, and may conveniently be attached to central member 250 via adhesive, friction, or any of a variety of methods well known in the art. It will also be apparent to practitioners of ordinary skill in the art that rib elements 52, 152, 252 may be formed via a variety of methods including extrusion, adhesive attachment, forming indentations in the outer surface of columns 50, 150 or inserts 256, 257, and other methods well known in the art, and that rib elements 52, 152, 252 may be of a wide variety of shapes including without limitation semicircular, trapezoidal, or made up of a plurality of individual protrusions.

Lower clip member 30 may conveniently be attached to base member 10, 210 via a fastener, such as a threaded bolt or stud 12 and nut 14. As is discussed below, it is convenient to raise lower clip member 30 off the surface of base member 10, and this may be accomplished via the use of a lid element 20, described below, or with a spacer 15. Base member 110 may conveniently be formed of molded plastic and lower clip member 30 may also be molded directly into lower base member 110 or lid member 20 or attached with adhesives.

Lower clip member 30 is adapted to engage at least one lower rib element 52, 152, 252, when column member 50, 150, or insert 256 is placed over lower clip member 30 and rotated, whereby base member 10, 110, 210 lower clip member 30, and column member 50 are joined into a trophy assembly. Preferably, lower clip member 30 will be adapted to engage four, evenly spaced lower rib elements 52, 152, 252, thereby providing even support about the circumference of column member 50, 150, 250. Practitioners of ordinary skill in the art will recognize that many configurations of rib elements and clip members are possible and the present invention is not limited to any single configuration. By way of example only and without limitation, column 50 may conveniently be formed with any number of rib elements, or with inwardly extending ribs connecting to a central support member (not shown) running the length of column 50, thereby providing increased rigidity and strength and allowing for additional configurations of lower clip member 30. Practitioners will also recognize that, once column member 50, lower clip member 30, and base member 10, 110, 210 are joined, additional decorative elements 60 including FIG. 64 or shapes (not known) may be attached to column end 57 via means that are well known in the art, including without limitation friction and adhesive attachment, to complete aesthetically pleasing trophies in a virtually unlimited variety of sizes and configurations. Alternatively, FIG. 64 may include a base with an attached upper clip 31 and stop 22, each described more fully below, whereby FIG. 64 may be attached to column 50, 150 or insert 257 by placing FIG. 64 over column 50, 150 or insert 257 and rotating FIG. 64 whereby upper clip 31 engages rib elements 52, 152, 252. Upper clip 31 may be attached via a threaded stud and nut, adhesive, via protrusions 35 adapted to engage holes 37 formed in upper clip 31 or may be or formed directly into the base of FIG. 64. FIG. 64 may also include a threaded stud 62 by which it may be attached to an upper lid element 21, described more fully below, with attached upper clip 31, also described more fully below.

In addition to lower clip members 30, 130, 230, 330, and 430, each described more fully below, other lower means attached to base member 10, 110, 210 may also be utilized to engage lower rib element 54, 154, 254 including clips adapted to engage angled slots in said rib elements, clips adapted to engage holes or indentations in said rib elements, clips adapted to engage a central member connected to said rib elements, clips adapted to frictionally engage lower rib elements without holes, indentations, or slots, clips adapted to adhesively engage lower rib elements, and clips adapted to engage complex rib arrangements.

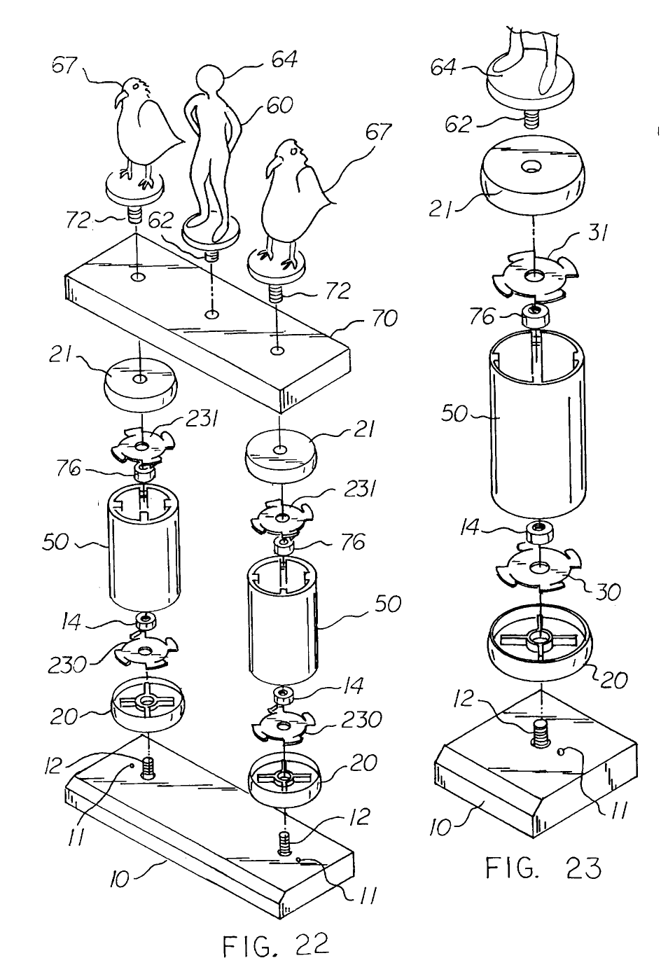

More complex and multi-level trophy assemblies may be created by adding additional column members 50 and upper element 70 and then utilizing upper member 70 as a base member for additional levels or a FIG. 64 and other decorative elements 67, such as is shown in FIG. 22. In such configurations upper clip member 31, 231 may conveniently be attached to upper element 70 via a threaded bolt or stud 72, 62 and nut 66, 76, or by the same methods described above by which lower clip member 30 may be attached to base member 10, 110, 210. In such configurations, the second end of column member 50 also has inwardly extending upper rib elements formed either individually 152, 252, or as a continuous rib element 52. Upper clip member 31, 231 may be substantially identical to lower clip member 30, 130, 230, 330, 430, but adapted so that, when attached to upper element 70, inverted, and placed within second column end 57, 157, 257, and column 50, 150, and 250 is rotated, upper rib elements 152, 252 or upper portion of rib element 52 simultaneously engage lower clip member 30, 130, 230, 330, 430 and upper clip member 31, 231, whereby base member 10, 110, 210, column member 50, and upper member 70 are joined together. Whereas in a single column trophy assembly upper clip member 31, 231 and lower clip member 30, 130, 230, 330, 430 may be adapted to engage upon opposite directions of rotation, in multi-column trophy applications, upper clip member 31, 231 and lower clip member 30, 130, 230, 330, 430 must be adapted such that both clip members engage upon rotation of column member 50 in the same direction. As with lower clip member 30, a spacer 15 or lid member 21 may conveniently be interposed between upper clip member 31, 231 to lower it below the surface of upper member 60 or FIG. 70. In addition to upper clip members 31, 231 and configurations substantially identical to lower clip members 130, 330, and 430, each described more fully below, other upper means attached to upper member 60, 70 may also be utilized to engage upper rib elements 152, 252 or upper portion of rib element 52, including all such means described above.

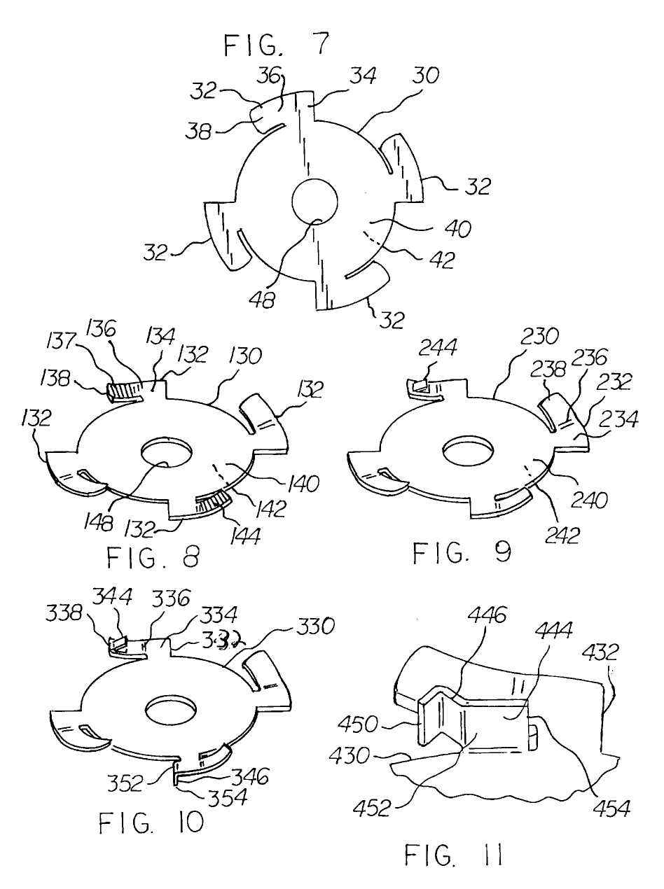

As is illustrated in FIGS. 7-16, several configurations of lower clip member 30, 130, 230, 330, 430 and upper clip member 31, 231 may conveniently be used. As is discussed above, lower clip members and upper clip members used in any given assembly may be largely identical, with the exception that lower clip members are adapted to be mounted to base members and upper clip members are adapted to be mounted to upper members with tab direction and angle altered, such that both lower and upper clip members engage simultaneously upon rotation of said column member. In one embodiment, lower clip member 30 comprises a generally planar element preferably made from stamped metal. Lower clip member 30 has obverse side 40 and reverse side 42 and is adapted such that reverse side 42 faces base member 10, 110, 210 when mounted. Radiating from center point 48, may conveniently be at least two, and preferably four, tab elements 32. Each tab element 32 comprises a generally coplanar first tab portion 34, a tab end 38, and intermediate tab portion 36 extending in between. For use with such a configuration, lower rib element 52 may conveniently have slot 54 formed therein, having a first slot side and a second slot side, adapted such that tab elements 32 engage slots 54 when column 52 is placed over lower clip member 30 and rotated and tab end 38 enters the first slot slide and progresses toward the second slot side.

In an alternate embodiment, and to provide additional rigidity and strength to the completed assembly, tab end 138 may be displaced from the plane of obverse side 140 such that an inclined plane is formed between tab end 138 and first tab portion 134. In this way, column member 50 is compressed against base member 10, 110, 210 as column member 50 is rotated.

Further alternate embodiments may conveniently be utilized to resist over-rotation and reverse rotation once tab elements 32, 132, 232, 332, 432 engage slots 54, 154, 254. The simplest such embodiment adds a stamped pattern, such as a set of parallel ridges 137 to the surface of tab elements 132, whereby the coefficient of friction between tab elements 132 and rib elements 52, 152, and 252, is increased and over-rotation and reverse rotation require additional force. Another such embodiment adds a latching mechanism 244, 344, 444 to at least one, and preferably two, of tab element 232, 332, 432 such that latching mechanism 244, 344, 444 are adapted to limit column rotation. Latching mechanism 244, 344 may conveniently comprise a resiliently deflectable flap attached proximate to tab end 238, 338 and displaced from intermediate tab portion 236, 336. Displaced flap end is adapted to interfere with and be resiliently deflected by rib element 52 upon tab element 232, 332 entering slot 54 and to latchingly engage rib element 52 upon passing beyond the second slot side. In this way, deflectable flap 244, 344, allows forward rotation into slot 54, but prevents reverse rotation once tab element 232, 332 is fully engaged. Similarly, latching mechanism 444 may be included on at least one, and preferably two, of tab element 432. Latching mechanism 444 comprises displaced catch 450, intermediate resilient portion 452, and attached catch portion 454. Latching mechanism 444 may be generally perpendicular to tab element 432 and adapted such that displaced catch 450 interferes with, and is resiliently deflected in by rib element 52 when tab element 432 enters slot 54 and latching engages rib element 52, whereby reverse rotation is inhibited once tab element 432 is fully engaged.

At least one, and preferably two, tab elements 36, 136, 236,336 may further comprise a stopping catch 346 to prevent over-rotation. Stopping catch 346 may conveniently comprise an attached stopping catch end 352 attached to tab element 342 proximate to first tab end 334 and a displaced stopping catch end 354, adapted to interfere with rib element 52 upon tab element 342 fully engaging slot 54 and prevent tab element 342 from rotating out of the second slot side.

Other means for limiting rotation of column member 52 upon engagement of tab elements 32, 132, 232, 332, 432 may also be utilized, and will be apparent to those of ordinary skill in the art, including the use of flaps, dimples, ridges, textures, adhesives, friction-enhancing coatings, catches adapted to engage rib element 52, catches adapted to engage inside column surface 58, partial slots 54, and offset tab placements utilized in combination with at least one unslotted rib element.

The trophy assembly of the present invention may further comprise lid member 20,21 interposed between base member 10 and lower clip member 30, 130, 230, 330, 430 or between FIG. 64 and upper clip 31. When utilizing a lid member 20, lower clip member 30, 130, 230, 330, 430 may be attached to base member 10 and generally concentrically with lid member 20, as is illustrated in FIG. 1. In such an embodiment, lid member 20 raises lower clip member 30, 130, 230, 330, 430 so that tab elements 32, 132, 232, 332, and 432 are correctly positioned to engage slots 54, 154, 254. Lid member 20 may also serve the further purpose of limiting forward rotation of column member 52 by further comprising at least one stop 22 adapted to engage rib element 52 upon tab elements 32, 132, 232, 332, and 432 fully engaging slots 54, 154, 254. Additionally, lid member 20 may further comprise a recess 24 adapted such that column member 52 may fit over lower clip member 30, 130, 230, 330, 430 and within recess 24, thereby improving both the appearance of the final trophy assembly as well as its structural rigidity. Lid member 20 may conveniently be formed of molded plastic or any other suitably rigid material, and stop 22 may conveniently be formed as a separate molded element within lid 20, or as an offset portion of a molded support structure 26 adapted to raise lower clip member 30, 130, 230, 330, 430 as is described above. Lid member 20 may also comprise a dimple or protrusion 21 on its bottom surface adapted to engage an alignment hole 11 in base 10 to prevent lid rotation and ensure proper alignment, such that the orientation of base member 10, column 50 and FIG. 64 will be correct when assembly is completed. Upper clip 31 may similarly be adapted to be attached to upper clip 31 and be interposed between upper FIG. 64 and column 50.

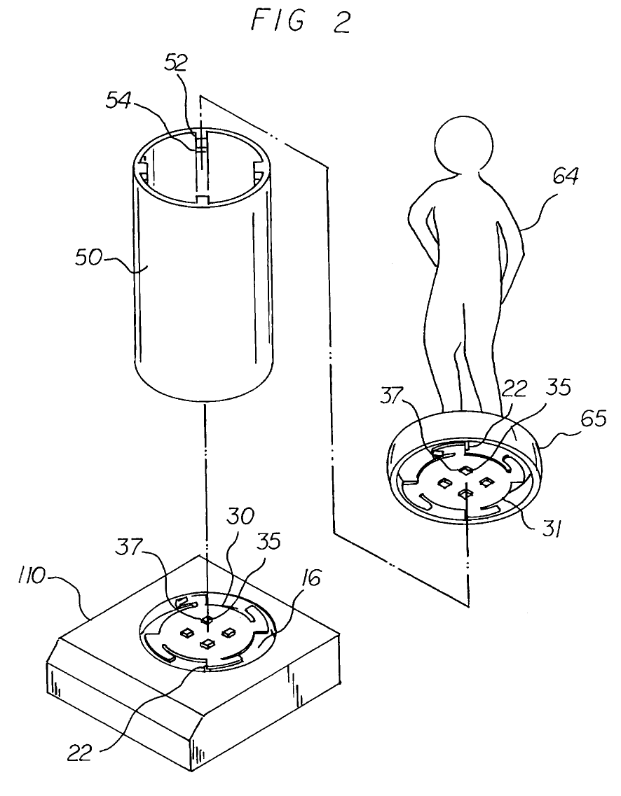

As is shown in FIGS. 2, 3, and 17, base member 210 may further comprise a recess 16 adapted such that lower clip member 30, 130, 230, 330, 430 may be attached to base member 210 within recess 16 and column member 50 may fit simultaneously over lower clip member 30, 130, 230, 330, 430 and within recess 16. As with lid elements 20, 21, attachment of clip members 30, 130, 230, 330, 430 to base 210 may be via a threaded stud or bolt and nut, protrusions 35 adapted to engage holes 37, friction, adhesive or via other means well known in the art. Alternatively, clip members 30, 130, 230, 330, 430, may be molded into or integral with base element 110. In such embodiments the appearance and structural rigidity of the trophy assembly may be improved by adapting recess 16 to conceal and support first end 56 without requiring the use of a lid, as is illustrated in FIG. 17. Further, recess 16 may also serve the further purpose of limiting rotation of column member 52 by further comprising at least one stop 22 adapted to engage rib element 52 upon tab elements 32, 132, 232, 332, and 432 fully engaging slots 54, 154, 254. As with lid element 20, base member 10, 110, 210 may be conveniently formed of molded plastic, or may be formed of metal, wood, wood composite, or other suitable materials well known in the art. Similar to base element 110, 210, upper member 70 may be formed with a corresponding recess (not shown) adapted such that upper clip 31, 231 may be attached with the corresponding recess. In such configurations, lower clip members 30, 130, 230, 330, 430 may be pre-attached to base member 10 and upper clip members 31, 231 may be pre-attached to upper members 70, whereby final assembly is reduced to placing column members 50 over lower clips 30, 130, 230, 330, 430, placing upper member 70 over column members 50 and twisting column members 50 such that lower clips 30, 130, 230, 330, 430 and upper clips 31, 131 engage rib elements 52, 152, 252 and the assembly is completed.

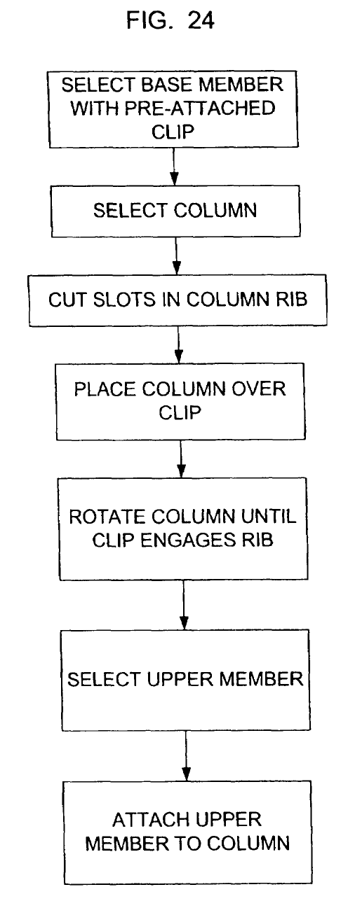

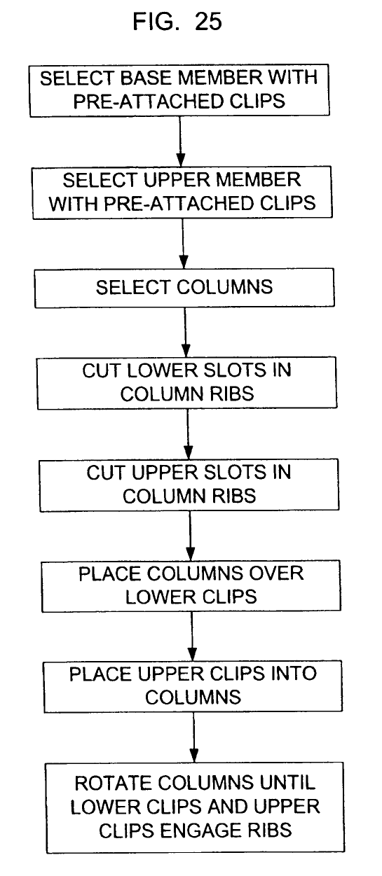

The present invention also includes a method of assembling a trophy as is illustrated in FIGS. 24 and 25. One embodiment of the method is illustrated in FIG. 24 and is directed at assembling a single-level trophy such as the trophy shown in FIG. 2 and comprises the steps of selecting a base member 10, 110, 210 with pre-attached lower clip member 30. Pre-attachment may conveniently be via a bolt 12 or other suitable fastener, or via a stud may be incorporated into base member 110. Alternatively, the pre-attachment may be made via adhesive, friction, the use of protrusions adapted to engage holes 37 or via other means well known in the art. Subsequent steps comprise selecting a column member 50 having at least one inwardly and longitudinally extending rib element 52, and cutting slots 54 into rib element 52, such that slots 54 are adapted to be engaged by lower clip member 30. If desired, additional slots 54 may also be cut into rib elements 52, such that the additional slots 54 are adapted to be engaged by upper clip member 31. However, it is noted that upper members such as figures may also be attached to the trophy assembly via other means, thereby eliminating the need for an upper clip. Remaining steps comprise placing column member 50 over clip member 30 and rotating column member 50 until lower clip member 30 fully engages slots 54, whereby base member 10, 110, 210 and column member 50 are joined together and attaching an upper member such as a figure. If an upper member 60 is to be attached by means of an upper clip member 31, the attachment may be completed by placing the upper member 60 over column member 50 and rotating the upper member 60 until upper clip member 31 fully engages additional slots 54.

A second embodiment of the method is illustrated in FIG. 25 and is directed at assembling a trophy with a plurality of columns and at least one upper member 70, such as is illustrated in FIG. 22, and comprises the steps of selecting a base member 10, 110, 210 with pre-attached lower clip members 30 and an upper member 70 with similarly pre-attached upper clip members 31. Columns 50 having at least one inwardly and longitudinally extending rib element may then be selected and slots 54 may be formed within rib element 52 proximate to each end of each column 50 such that slots are adapted to engage clip members 30 and 31 respectively. Subsequent steps comprise placing column members 50 over lower clip members 30, placing attached upper clip members 31 into columns 50, and then rotating columns 50, whereby base member 10, 110, 210 upper member 60 or 70, and column members 50 are joined together.

Those of ordinary skill in the art will recognize that additional steps may be added to the above embodiments of the assembly method and that other obvious orderings of the steps, including steps involving pre-attachment of clips to base members and upper members, are also effective and within the scope of the present invention.

While the foregoing describes preferred embodiments of the trophy assembly and method of this invention, it is to be understood that this description is to be considered only as illustrative of the principles of the invention and is not to be limitative thereof, as numerous other variations, all within the scope of the invention will readily occur to others.

I claim:

1. A trophy assembly comprising
a base member, a column member, and a lower clip member attached to said base member wherein
said column member has a first column end and a second column end;
said first column end has a first column end interior column surface configured and dimensioned to fit over said lower clip member and at least one inwardly and longitudinally extending lower rib element;
said lower clip member is configured and dimensioned to engage at least one said lower rib element when said column member is placed over said lower clip member and rotated; and
said column member engages said lower clip member attached to said base member, whereby said base member and said column member are joined together.

2. A trophy assembly as in claim 1 further comprising an upper member and at least one upper clip member attached to said upper member, wherein
said second column end has a second column end interior surface configured and dimensioned to fit over said upper clip member and at least one inwardly extending upper rib element;
said upper clip member is configured and dimensioned to engage at least one said upper rib element when said column member is placed over said upper clip member and rotated; and
said column member further engages said upper clip member attached to said upper member, whereby said base member, said column member, and said upper member are joined together.

3. A trophy assembly as in claim 1 wherein
said first column end has at least two inwardly extending lower rib elements,
said lower clip member comprises a generally planar element having a body with a center point and an obverse side and a reverse side and at least two tab elements, each said tab element comprising a first tab portion generally coplanar, joined to, and extending outwardly from said generally planar element body, a tab end displaced from said first tab portion, and an intermediate tab portion extending between said first tab portion and said tab end; and
each said lower rib element has a slot having a first slot side and a second slot side, said slot being positioned and dimensioned such that said tab elements engage said slots when said column member is placed over said lower clip member and rotated.

4. A trophy assembly as in claim 3 wherein said tab element further comprises a means for limiting rotation of said column member upon said tab elements engaging said slots.

5. A trophy assembly as in claim 3 wherein
said tab end is displaced from said first tab end and displaced from the plane of said obverse side, and
said intermediate tab portion extending between said first tab portion and said tab end forms an inclined plane.

6. A trophy assembly as in claim 3 wherein each said tab element further comprises a surface pattern that serves to increase the coefficient of friction between said tab element and said engaged slot.

7. A trophy assembly as in claim 3 wherein at least one said tab element further comprises a latching mechanism dimensioned and configured such that said latching mechanism latchingly engages said lower rib element to limit rotation of said column element wherein
said latching mechanism comprises a resiliently deflectable flap having an attached flap end and a displaced flap end;
said attached flap end is attached to said tab element proximate to said tab end, and said displaced flap end is displaced from said intermediate tab portion; and
said flap is configured and dimensioned to interfere with and be resiliently deflected by said lower rib element upon said tab element entering said slot from said first slot side and to latchingly engage said lower rib element upon said displaced flap end passing beyond said second slot side, whereby the tab element is prevented from reversibly rotating out of said slot.

8. A trophy assembly as in claim 3 wherein at least one said tab element further comprises a latching mechanism dimensioned and configured such that said latching mechanism latchingly engages said lower rib element to limit rotation of said column element wherein
said latching mechanism comprises a displaced catch, an intermediate resilient portion, and an attached catch portion;
said attached catch portion is generally perpendicular to and attached to said tab element;
said intermediate resilient portion is resiliently attached to said attached catch portion, and said displaced catch is attached to said resilient portion; and
said latching mechanism is configured and dimensioned such that said displaced catch interferes with and is resiliently deflected by said lower rib element upon said tab element entering said slot from said first slot side and latchingly engages said lower rib element upon said tab engaging said slot, whereby said tab element is resisted from reversibly rotating out of said slot.

9. A trophy assembly as in claim 3 wherein one said tab element further comprises a stopping catch dimensioned and configured such that said stopping catch engages said lower rib element upon said tab element fully engaging said slot, whereby said tab element is resisted from rotating past said second slot side, wherein
said stopping catch comprises an attached stopping catch end and a displaced stopping catch end;
said attached stopping catch end is attached to said tab element proximate to said first tab end, and said displaced stopping catch end is displaced from said first tab end; and
said stopping catch is configured and dimensioned to interfere with said lower inwardly extending element upon said tab element engaging said lower inwardly extending element, whereby the tab element is prevented from rotating past said second slot side.

10. A trophy assembly as in claim 3 further comprising a lid member interposed between said lower clip member and said base member, with said lower clip member being attached to said base member and generally concentric to said lid member.

11. A trophy assembly as in claim 10 wherein said lid member further comprises at least one stop that is sized, configured, and positioned such that said stop engages said lower rib element when said tab elements engage said slots thereby preventing further rotation of said column member.

12. A trophy assembly as in claim 10 wherein said lid member further comprises a recess, with said generally planar element being attached within said recess and said column member being configured and dimensioned to fit within said recess and over said lower clip member.

13. A trophy assembly as in claim 1 wherein said base member has a recess dimensioned, positioned and configured such that said lower clip member may be attached to said base member within said recess and said first column end may fit within said recess and over said lower clip member.

14. A trophy assembly as in claim 13 wherein said recess further comprises at least one stop that is sized, configured, and positioned such that said stop engages said lower rib element when said lower clip member engages said lower rib element thereby preventing further rotation of said column member.

15. A trophy assembly comprising a base member, a column member, and lower means for attaching said column member to said base member wherein
said column member has a first column end and a second column end;
said first column end has a first column end interior column surface having at least one inwardly and longitudinally extending lower rib element; and
said lower means are attached to said base member and engage said lower rib element, whereby said base member and said column member are joined together.

16. A trophy assembly as in claim 15 further comprising an upper member and an upper means for attaching said upper member to said column member wherein
said second column end has a second column end interior surface having at least one inwardly extending upper rib element; and
said upper means for attaching said upper member to said column member are attached to said upper member and engage said upper rib element, whereby said base member, said column member, and said upper member are joined together.

17. A trophy assembly as in claim 15 further comprising a lid member interposed between said base member and said column member.

18. A trophy assembly as in claim 17 wherein said lid member further comprises at least one stop that is sized, configured, and positioned such that said stop engages said lower rib element thereby limiting rotation of said column member.

19. A trophy assembly as in claim 17 wherein said lid member further comprises a recess and said column member is configured and dimensioned to fit within said recess.

20. A trophy assembly as in claim 15 wherein said base member has a recess dimensioned, positioned and configured such that said first column end may fit within said recess.

21. A trophy assembly as in claim 20 wherein said recess further comprises at least one stop that is sized, configured, and positioned such that said stop engages said lower rib element thereby limiting the rotation of said column member.

22. A method of assembling a trophy comprising the steps of
selecting a base member with a pre-attached lower clip member, and a column member, said column member having a first column end and a second column end, said first column end having a first column end interior and at least one inwardly and longitudinally extending lower rib element;
forming a slot in said lower rib element, said slot being proximal to said first column end;
placing said first column end over said lower clip member and rotating said column member whereby said lower clip member engages said slot and said base member, and column member are joined together.

23. The method of claim 22 wherein said column said second column end has a second column end interior and at least one inwardly and longitudinally extending upper rib element and further comprising the steps of
forming an upper slot in said upper rib element, said upper slot being proximal to said second column end;
selecting an upper member with a preattached upper clip member;
placing said upper member over said second column end and rotating said upper member whereby said upper clip member engages said upper slot and said upper member, column member, and base member are joined together.

24. A method of assembling a trophy comprising the steps of
selecting a base member with a plurality of preattached lower clip members, an upper member with a plurality of preattached upper clip members, and a plurality of column members, said column members having a first column end and a second column end, said first column end having a first column end interior and at least one inwardly and longitudinally extending lower rib element and said second column end having a second column end interior and at least one inwardly and longitudinally extending upper rib element;
forming a lower slot in said lower rib elements, said slots being proximal to said first column end;
forming an upper slot in said upper rib elements, said slots being proximal to said second column end;
placing said first column ends over said lower clip members;
placing said upper clip members within said second column ends, and
rotating said column members whereby said lower clip members engage said lower slots, said upper clip members engage said upper slots, and said base member, said upper member, and said column members are joined together.
